(19) United States
(12) Patent Application Publication
(10) Pub. No.: US 2014/0176777 A1
(43) Pub. Date: Jun. 26, 2014

(54) METHOD FOR CONTROLLING ELECTRONIC DEVICE AND ELECTRONIC DEVICE

(71) Applicant: LENOVO (BEIJING) CO., LTD., Beijing (CN)

(72) Inventor: Xida Lu, Beijing (CN)

(73) Assignee: LENOVO (BEIJING) CO., LTD., Beijing (CN)

(21) Appl. No.: 14/138,640

(22) Filed: Dec. 23, 2013

(30) Foreign Application Priority Data
Dec. 25, 2012 (CN) 201210570583.2

(51) Int. Cl. H04N 5/232

(52) U.S. Cl. CPC H04N 5/23212; H04N 5/23293; H04N 5/23219
USPC 348/333.11

(57) ABSTRACT

a method for controlling an electronic device and an electronic device are provided, the method being applicable to an electronic device including a display unit, a first image acquisition unit and a second image acquisition unit, wherein the first image acquisition unit can determine a different acquisition region based upon a different focusing parameter, and the method includes: in the case where an image of a first acquisition region is acquired by the first image acquisition unit, obtaining by the second image acquisition unit a first line-of-sight focus of a first user observing a preview image displayed on the display unit; determining a first photographing focus of the first image acquisition unit based upon the first line-of-sight focus; and acquiring by the first image acquisition unit a first image of the first acquisition region based upon the first photographing focus.

### CROSS-REFERENCES TO RELATED APPLICATIONS

The present application claims priority to Chinese Patent Application No. 201210570583.2, filed with the State Intellectual Property Office of People's Republic of China on Dec. 25, 2012 entitled “METHOD FOR CONTROLLING ELECTRONIC DEVICE AND ELECTRONIC DEVICE”, the content of which is incorporated herein by reference in its entirety.

### TECHNICAL FIELD

The present invention relates to the field of electronic technology and in particular to a method for controlling an electronic device and an electronic device.

### BACKGROUND

Thanks to the constant development of sciences and technologies, electronic technologies have also been developed rapidly, an increasing number of electronic products also have emerged, and people also have enjoyed various conveniences resulting from the development of sciences and technologies. People now can enjoy their comfortable life by means of their various types of electronic devices due to the development of sciences and technologies. For example, digital cameras and other electronic devices have become an important component of people's life so that users can take a picture or video using their digital cameras and other electronic devices to thereby memorize unforgettable moments in their life.

At present both an electronic device configured with a photographing function and a professional photographing device are configured with a manual focusing or automatic focus function, where manual focusing refers to a focusing scheme with manual rotation of a lens focusing ring of the electronic device or with pressing a focusing button on the electronic device for the purpose of being in focus to thereby take a picture with a good effect; and there are numerous schemes of automatic focusing, for example, under the principle of light reflection by an object, reflected light is received by an optical sensor on the electronic device and processed by the electronic device to have an electrical focusing unit operated for focusing to thereby take a photo with a good effect, and in another example, a focus is adjusted onto a human face after the human face is recognized with human face recognition.

However the present inventors have identified during making of embodiments of the invention at least the following technical problems in the prior art:

1. The scheme of manual focusing may be inefficient in that a user has to manually adjust himself or herself the lens focusing ring of the electronic device or press the focusing button on the electronic device and also the user has to be somewhat professional, and the electronic device has to respond to the manual operation by the user for the purpose of accurate focusing, thus resulting in the technical problem of the scheme of manual focusing being inefficient; and

2. The scheme of automatic focusing may be inaccurate in that, for example, when the user desires a flower to be in focus in an image including a person, the flower, a tree, etc., the electronic device may automatically have the person in focus, thus resulting in the technical problem of the scheme of automatic focusing being inaccurate with focusing.

### SUMMARY

According to the embodiments of the invention, a method for controlling an electronic device and an electronic device are provided to address the technical problems in the prior art of a manual focusing scheme being inefficient and of a scheme of automatic focusing being inaccurate with focusing.

According to an aspect of the embodiments the invention, it is provided a method for controlling an electronic device, the method being applicable to an electronic device including a display unit, a first image acquisition unit and a second image acquisition unit, herein the first image acquisition unit is configured to determine a different acquisition region based upon a different focusing parameter, and the method includes: obtaining, by the second image acquisition unit, a first line-of-sight focus of a first user viewing a preview image display unit in the case where an image of a first acquisition region is acquired by the first image acquisition unit; determining a first photographing focus of the first image acquisition unit based upon the first line-of-sight focus; and acquiring by the first image acquisition unit a first image of the first acquisition region based upon the first photographing focus, wherein a first section image in the first image has a higher definition than that of another section image in the first image than the first section, and the first section image is an image corresponding to the first photographing focus.

Optionally the electronic device further includes an obliquity detection unit, and after the first line-of-sight focus of the first user operating the electronic device is obtained by the second image acquisition unit, and before the first photographing focus of the first image acquisition unit is determined, the method further includes: obtaining, by the obliquity detection unit, an obliquity of the electronic device;

where the determining a first photographing focus of the first image acquisition unit based upon the first line-of-sight focus includes: determining first photographing focus of the first image acquisition unit based upon the first line-of-sight focus and the obliquity.

Optionally the determining a first photographing focus of the first image acquisition unit based upon the first line-of-sight focus includes: determining a first position of the first photographing focus on the display unit; determining the first position to correspond to a first sub-region of the first acquisition region; and determining the first sub-region as the first photographing focus.

Optionally the determining a first position of the first photographing focus on the display unit includes: judging whether the line-of-sight focus stays at the first position for a period of time above a preset length of time; and determining the line-of-sight focus to be at the first position in the case where the line-of-sight focus stays for the period of time above the preset length of time.

Optionally after the first line-of-sight focus of the first user operating the electronic device is obtained by the second image acquisition unit, and before the first photographing focus of the first image acquisition unit is determined, the method further includes: obtaining first correction data; and correcting the first line-of-sight focus to a second line-of-sight focus based upon the first correction data, wherein the first line-of-sight focus is different from the second line-of-sight focus.

According to another aspect of the embodiments the invention, it is provided an electronic device including: a housing; a circuit board arranged inside the housing; a processor arranged on the circuit board; a first image acquisition unit arranged on the housing and connected with the processor to acquire an image of a first acquisition region; a second image acquisition unit arranged on the housing and connected with the processor to obtain a line-of-sight focus of a first user; and a display unit arranged on the housing and connected with the processor, where in the case where the image of the first acquisition region is acquired by the first image acquisition unit, the processor is configured to obtain by the second image acquisition unit a first line-of-sight focus of the first user viewing a preview image displayed on the display unit, to determine a first photographing focus of the first image acquisition unit based upon the first line-of-sight focus, and to acquire by the first image acquisition unit a first image of the first acquisition region based upon the first photographing focus, wherein a first section image in the first image has a higher definition than that of another section image in the first image than the first section, and the first section image is an image corresponding to the first photographing focus.

Optionally the electronic device further includes an obliquity detection unit, and the processor is further configured to obtain an obliquity of the electronic device by the obliquity detection unit and to determine the first photographing focus based upon the first line-of-sight focus and the obliquity.

Optionally the processor is further configured to determine a first position of the line-of-sight focus on the display unit, to determine the first position to correspond to a first sub-region of the first acquisition region and to determine the first sub-region as the first photographing focus.

Optionally the processor is further configured to judge whether the line-of-sight focus stays at the first position for a period of time above a preset length of value, and to determine the line-of-sight focus to be at the first position in the case where the line-of-sight focus stays for the period of time above the preset length of time.

Optionally the processor is further configured to obtain first correction data and to correct the first line-of-sight focus to second line-of-sight focus, wherein the first line-of-sight focus is different from the second line-of-sight focus.

The technical solutions in the embodiments according to the embodiments of the invention have at least the following technical effects or advantages.

1. Due to the use of the technical solution in which the first line-of-sight focus of the first user is obtained, the first photographing focus of the first image acquisition unit is determined based upon the first line-of-sight focus, and the first image of the first acquisition region is acquired by the first image acquisition unit based upon the first photographing focus, the electronic device does not need to respond to any operation by the user to manually adjust the electronic device for focusing but instead determines the photographing focus of the image acquisition unit based upon the line-of-sight focus of the user to thereby achieve a technical effect of the scheme of focusing being more efficient than manual focusing.

2. Due to determination of the photographing focus of the electronic device based upon the line-of-sight focus of the user, the determined photographing focus is a photographing focus selected by the user himself or herself so that there is a technical effect of the scheme of focusing being more accurate than automatic focusing.

3. Due to the technical solution in which the obliquity of the electronic device is obtained by the obliquity detection unit, the first photographing focus is determined based upon the obliquity and the first line-of-sight focus, and the image is acquired based upon the first photographing focus, the determined photographing focus is a section indeed desirable for focusing by the user, thereby determining the photographing focus of the electronic device more accurately and thus further achieving the technical effect of accurate focusing.

4. Due to the technical solution in which the first line-of-sight focus is corrected based upon the first correction data, the corrected second line-of-sight focus can be closer to the section indeed desirable for focusing by the user, thereby further achieving the technical effect of accurate focusing.

### BRIEF DESCRIPTION OF THE DRAWINGS

FIG. 1 is a flow chart of a method for controlling an electronic device according to an embodiment of the invention;

FIG. 2 is a schematic diagram of acquisition of an image by an electronic device according to an embodiment of the invention;

FIG. 3 and FIG. 4 are schematic diagrams of acquisition of an image by an electronic device at an obliquity according to another embodiment of the invention; and

FIG. 5 is a functional module diagram of an electronic device according to an embodiment of the invention.

### DETAILED DESCRIPTION

According to the embodiments of the invention, a method of controlling an electronic device and an electronic device are provided to address the technical problems in the prior art of a manual focusing scheme being inefficient and of a scheme of automatic focusing being inaccurate with focusing.

In order to address the foregoing technical problems of a manual focusing scheme being inefficient and of a scheme of automatic focusing being inaccurate with focusing, a general idea of the embodiments of the invention is as follows:

Firstly in the case where an image of a first acquisition region is acquired by a first image acquisition unit, a first line-of-sight focus of a first user viewing a preview image displayed on a display unit is obtained by a second image acquisition unit;

Then a first photographing focus of the first image acquisition unit is determined based upon the first line-of-sight focus; and

Lastly a first image of the first acquisition region is acquired by the first image acquisition unit based upon the first photographing focus, where a first section image in the first image has a higher definition than that of another section image in the first image than the first section, and the first section image is an image corresponding to the first photographing focus.

As can be apparent from the foregoing description, an electronic device can achieve focusing without responding to any manual operation by a user, so there is a technical effect of an efficient focusing scheme as compared with manual focusing; and the photographing focus of the image acquisition unit is determined based upon the line-of-sight focus of the user, so there is a technical effect of an accurate focusing scheme as compared with automatic focusing.

In order to better understand the foregoing technical solution, the technical solution will be described below in details with reference to the drawings and particular embodiments.

According to an embodiment of the invention, it is provided a method for controlling an electronic device, the method being applicable to an electronic device including a display unit, a first image acquisition unit and a second image acquisition unit, where the first image acquisition unit can determine a different acquisition region based upon a different focusing parameter, and in a practical application, the electronic device may be a digital camera or may be a smart phone, and of course, it may alternatively be another device of the same type without any limitation thereto. The following detailed description will be given by way of an example with the electronic device being a digital camera.

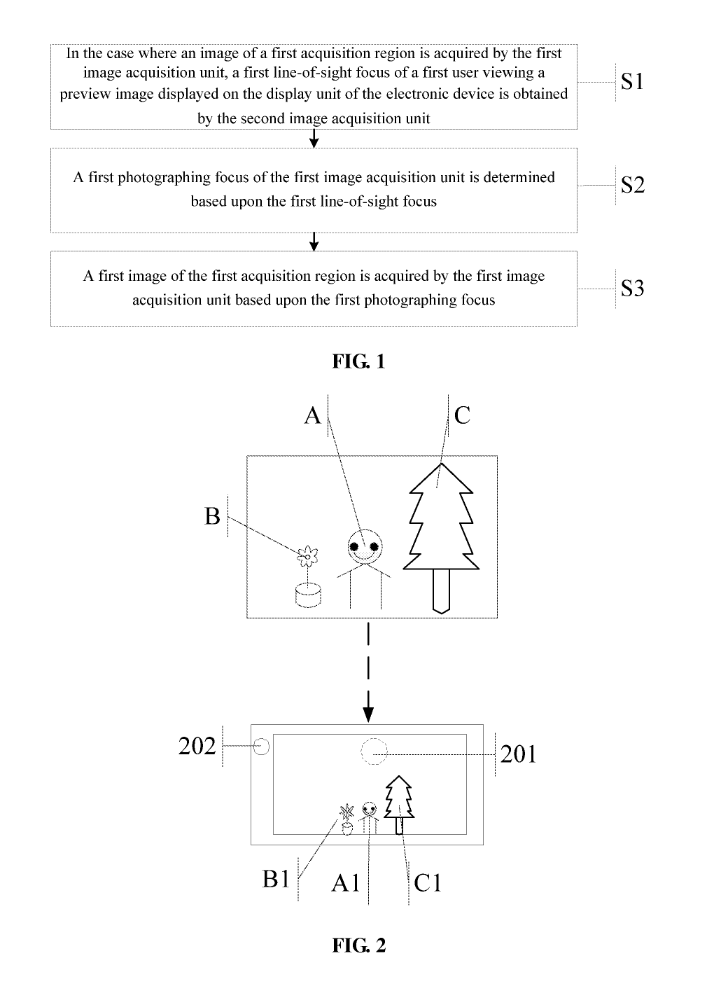

Further referring to FIG. 1 illustrating a flow chart of a method for controlling an electronic device according to an embodiment of the invention, the method includes:

S1: In the case where an image of a first acquisition region is acquired by the first image acquisition unit, a first line-of-sight focus of a first user viewing a preview image displayed on the display unit of the electronic device is obtained by the second image acquisition unit;

S2: A first photographing focus of the first image acquisition unit is determined based upon the first line-of-sight focus; and

S3: A first image of the first acquisition region is acquired by the first image acquisition unit based upon the first photographing focus, where a first section image in the first image has a higher definition than that of another section image in the first image than the first section, and the first section image is an image corresponding to the first photographing focus.

In this embodiment, the first image acquisition unit may be a post-positioned pickup head of a digital camera to acquire the image of the first acquisition region, and the second image acquisition unit may be a pre-positioned pickup head of the digital camera to obtain a line of sight of the user.

In the step S1, the first line-of-sight focus of the first user viewing the preview image displayed on the display unit of the electronic device is obtained by the second image acquisition unit, and particularly human face information of the first user operating the electronic device can be obtained by the second image acquisition unit, and after the human face information of the first user is obtained, a central position of pupils of eyes in the first user can be captured, so that a region at which the eyes of the first user look can be calculated to thereby obtain the first line-of-sight focus of the first user.

Of course, from the foregoing introduction, those skilled in the art can further obtain otherwise the first line-of-sight focus of the first user, for example, infrared light is emitted to the eyes of the user, and after the infrared light is reflected by retinas in the eyes of the first user, an eye controlled focusing sensor of the electronic device can calculate the region at which the eyeballs of the first user look upon reception of the reflected infrared light to thereby obtain the first line-of-sight focus of the first user. Of course, in a practical application, those skilled in the art can further otherwise do this appropriately under a practical condition to accommodate a need under the practical condition, so a repeated description thereof will be omitted here.

After the first line-of-sight focus of the first user is obtained in the step S1, the first photographing focus of the first image acquisition unit can be determined based upon the first line-of-sight focus, that is, the step S2 is performed.

In the step S2, determination of the first photographing focus of the first image acquisition unit based upon the first line-of-sight focus may particularly include:

S21: A first position of the first line-of-sight focus on the display unit is determined, and particularly the first position, on the display unit, of the first line-of-sight focus of the first user viewing the preview image displayed on the display unit can be determined based upon the first line-of-sight focus obtained in the step S1.

In a particular implementation, referring to FIG. 2 illustrating a schematic diagram of acquisition, by the digital camera according to the embodiment of the invention, the first acquisition region including a person A, a flower B and a tree C, the digital camera includes a post-positioned pickup head 201 and a pre-positioned pickup head 202, and in the case where the image of the first acquisition region is acquired by the post-positioned pickup head 201, a photosensitive element in the digital camera acquires images constantly, and these images are firstly buffered into a memory and displayed by the display unit of the digital camera, where such an image is referred to a preview image. In this embodiment, the preview image of the current acquisition region is displayed on the display unit of the digital camera, where the preview image includes a person A1, a flower B1 and a tree C1.

The first position of the first line-of-sight focus on the display unit can be determined based upon the first line-of-sight focus obtained in the step S1, and particularly, the first position, of the first line-of-sight focus of the first user, in the preview image displayed on the display unit is determined according to the first line-of-sight focus. For example, in this embodiment, if the first user intends to take a picture with the flower B in focus, then the first user only needs to look at the flower B1 in the preview image displayed on the display unit of the electronic device, that is, after the line-of-sight focus of the first user is obtained in the step S1, the first line-of-sight focus of the first user at that time can be determined to be on the flower B1 in the preview image displayed on the display unit.

In a particular implementation, the first position of the first line-of-sight focus on the display unit may be determined particularly by judging whether the line-of-sight focus stays at the first position for a period of time above a preset length of time and determining the line-of-sight focus to be at the first position in the case where it stays for the period of time above the preset length of time.

In a practical application, the first user generally has his or her line-of-sight focus changed while operating the electronic device. For example, the first user operating the electronic device may come to consider a layout of the entire picture so that the first user may look around the preview image displayed on the display unit, and at this time if a focus of the digital camera is determined based upon the line-of-sight focus of the first user, then the focus of the digital camera may be changing constantly, thus unnecessarily wasting power of the digital camera. Thus the first position of the line-of-sight focus of the first user on the display unit can be determined only if the line-of-sight focus stays at the first position for a period of time above a preset length of time.

For example, the preset length of time is set to 3 s, and of course, it may alternatively be set to another value, e.g., 4 s, 5 s, etc., and with a timer arranged in the electronic device, the timer starts counting when the line-of-sight focus of the first user comes to some position on the display unit, and if the line-of-sight focus of the first user moves to another position when the timers counts to less than 3 s, then the timer is reset and restarts counting.

In this embodiment, in the case where the line-of-sight focus of the first user stays on the flower B1 in the preview image displayed on the display unit for more than 3 s, the first line-of-sight focus of the first user can be determined to be on the flower B1 in the preview image displayed on the display unit.

As can be apparent from the foregoing description, the first line-of-sight focus can be determined to be at the first position only if the line-of-sight focus of the user stays at the first position for a period of time above a preset length of time to thereby achieve a technical effect of preventing focusing in error.

After the first line-of-sight focus is determined at the first position on the display unit, a region for focusing by the electronic device can be determined based upon the first position, that is, the following step S22 is performed.

S22: The first position is determined to correspond to a first sub-region of the first acquisition region based upon the first position, and particularly after the line-of-sight focus is determined at the first position on the display unit, the first position is determined to correspond to the first sub-region of the first acquisition region. In this embodiment, after the first line-of-sight focus of the first user is determined to be on the flower B1 in the preview image displayed on the display unit in the step S21, the flower B1 in the preview image displayed on the display unit is determined to correspond to the flower B in the first acquisition region.

After the first position is determined to correspond to the first sub-region of the first acquisition region, the first sub-region can be determined as the first photographing focus of the electronic device, that is, the following step S23 is performed.

S23: The first sub-region is determined as the first photographing focus, and particularly after the first position is determined to correspond to the first sub-region of the first acquisition region in the step S22, the first sub-region can be determined as a focus of the first image acquisition unit of the electronic device. In this embodiment, a section where the flower B1 is located in the first acquisition region can be determined as a first photographing focus of the post-positioned pickup head of the digital camera.

Of course, in a practical application, there may be more than one photographing focus of the electronic device, and a plurality of photographing focuses thereof are very likely; and as such, focuses as needed can be determined simply repeating the foregoing steps, and information about the focuses can be stored to thereby obtain the plurality of photographing focuses.

After the first photographing focus of the first image acquisition unit is determined in the step S2, the first image of the first acquisition region can be acquired by the first image acquisition unit based upon the first photographing focus, that is, the following step S3 is performed.

In the step S3, the first image of the first acquisition region is acquired by the first image acquisition unit based upon the first photographing focus, and particularly the first image of the first acquisition region acquired by the first image acquisition unit can be stored. In a practical application, storage of the first image of the first acquisition region acquired by the first image acquisition unit can be started upon reception of an operation instruction of the user, for example, when the user presses down a shutter, or the first image of the first acquisition region acquired by the first image acquisition unit can be recorded upon automatic startup of the shutter, and the invention will not be limited in this respect. In this embodiment, after the first photographing focus of the post-positioned pickup head of the digital camera is determined, the first image of the first acquisition region can be acquired by the post-positioned pickup head. In this embodiment, since the photographing focus of the post-positioned pickup is a section where the flower B is located, the section where the follower B1 is located in the first image has a higher definition than that of another section than the section where the flower B1 is located.

As can be apparent from the foregoing description, due to the use of the technical solution in which the first line-of-sight focus of the first user is obtained, the first photographing focus of the first image acquisition unit is determined based upon the first line-of-sight focus, and the first image of the first acquisition region is acquired by the first image acquisition unit based upon the first photographing focus, the electronic device does not need to respond to any operation by the user to manually adjust the electronic device for focusing but instead determines the photographing focus of the image acquisition unit based upon the line-of-sight focus of the user to thereby achieve a technical effect of the scheme of focusing being more efficient than manual focusing.

Also due to determination of the photographing focus of the electronic device based upon the line-of-sight focus of the user, the determined photographing focus is a photographing focus selected by the user himself or herself so that there is a technical effect of the scheme of focusing being more accurate than automatic focusing.

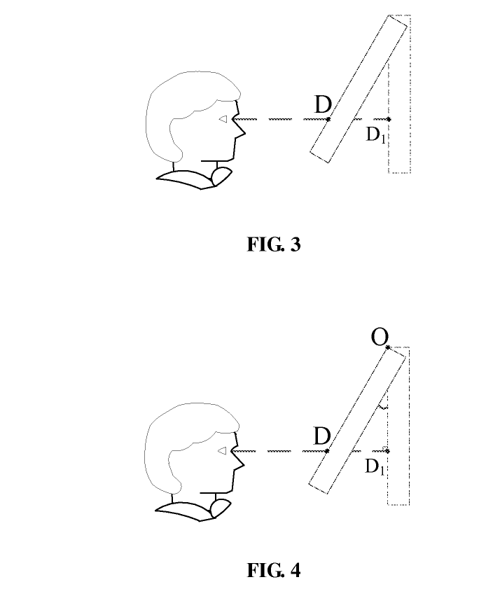

In operation of the electronic device, a plane where the face of the user is located may not be parallel to a plane where the display unit on the electronic device to display the preview image is located, but instead an angle may be present between the planes, as illustrated in FIG. 3. FIG. 3 is a schematic of photographing by the electronic device at an obliquity. As illustrated in FIG. 3, due to the obliquity of the electronic device itself, the electronic device might determine based upon the obtained line-of-sight focus that the user were looking at a point D₁ of the electronic device vertically positioned although actually the user looks a point D of the electronic device obliquely positioned, so the photographing focus determined at that time may not be a photographing focus desirable to the user, thus degrading the experience of the user.

Thus in order to determine the photographing focus of the electronic device more accurately, the electronic device may further include an obliquity detection unit in a particular implementation, and in a practical application, the obliquity detection unit may be an accelerator sensor or a gyroscope, and of course, it may alternatively be another apparatus capable of detecting the obliquity of the electronic device.

In a particular implementation, after the first line-of-sight focus of the first user operating the electronic device is obtained by the second image acquisition unit, and before the first photographing focus of the first image acquisition unit is determined, the method according to an embodiment of the invention further includes: obtaining an obliquity of the electronic device by the obliquity detection unit; and determining the first photographing focus of the first image acquisition unit based upon the first line-of-sight focus, and particularly determining the first photographing focus based upon the first line-of-sight focus and the obliquity.

Particularly the obliquity of the electronic device may be obtained by the obliquity detection unit of the electronic device, and after the obliquity of the electronic device is obtained, the first photographing focus of the first image acquisition unit may be determined based upon the first line-of-sight focus and the obliquity.

Referring to FIG. 4 illustrating a schematic diagram of determining the first photographing focus of the first image acquisition unit based upon the first line-of-sight focus and the obliquity according to an embodiment of the invention, the obliquity of the electronic device itself can be obtained by the obliquity detection unit, that is, the angle of the plane, where the display unit of the electronic device is located, to the vertical direction, i.e., a particular value of ∠D₁OD, can be obtained, and also the distance of D₁O in the vertical direction has been calculated by the electronic device, so the value of OD can be calculated based upon OD=OA/COS∠D₁OD to thereby determine accurately the first position of the first line-of-sight focus on the display unit, and thus the first position can be determined to correspond to the first sub-region of the first acquisition region to thereby determine the first sub-region as the first photographing focus of the first image acquisition unit.

After the first sub-region is determined as the first photographing focus of the first image acquisition unit, the electronic device can acquire an image by the first image acquisition unit based upon the determined first photographing focus to thereby obtain the image with accurate focusing, so a repeated description thereof will be omitted here.

Of course, from the foregoing introduction, those skilled in the art may otherwise obtain the obliquity of the electronic device and further determine the first photographing focus appropriately under a practical condition to accommodate a need under the practical condition, so a repeated description thereof will be omitted here.

As can be apparent from the foregoing description, due to the technical solution in which the obliquity of the electronic device is obtained by the obliquity detection unit, the first photographing focus is determined based upon the obliquity and the first line-of-sight focus, and the image is acquired based upon the first photographing focus, the determined photographing focus is a section indeed desirable for focusing by the user, thereby determining the photographing focus of the electronic device more accurately and thus further achieving the technical effect of accurate focusing.

In a particular implementation, due to the shape of eyes and the shape of pupils varying from one user to another as well as some strabismal user, after the first line-of-sight focus of the first user operating the electronic device is obtained by the second image acquisition unit, and before the first photographing focus of the first image acquisition unit is determined, the method according to an embodiment of the invention further includes: obtaining first correction data, and correcting the first line-of-sight focus to a second line-of-sight focus based upon the first correction data, where the first line-of-sight focus is different from the second line-of-sight focus.

Particularly the first correction data may be obtained in numerous ways, for example, obtained by an input apparatus, such as direction arrows, a touch pad and other input apparatuses of the electronic devices, or stored in a memory of the electronic device, from which the first correction data may be retrieved by the user operating the electronic device. Of course, in a practical application, those skilled in the art may further otherwise obtain the first correction data appropriately under a practical condition to accommodate a need under the practical condition, so a repeated description thereof will be omitted here.

After the first correction data is obtained, the next step is performed in which the first line-of-sight focus is corrected to the second line-of-sight focus based upon the first correction data. Particularly the first correction data may indicate the number of pixels by which the line-of-sight focus is moved upward or downward or the number of pixels by which it is moved leftward or rightward, for example, with the first correction data of (30, −10), it may indicate a need to move the first line-of-sight focus upward by 30 pixels and rightward by 10 pixels. The first line-of-sight focus is adjusted based upon the obtained first correction data to thereby obtain the second line-of-sight focus different from the first line-of-sight focus, and since the second line-of-sight focus is obtained by correcting the first line-of-sight focus of the user based upon the first correction data, the second line-of-sight focus can be closer to the section indeed desirable for focusing by the user, thereby further achieving the technical effect of accurate focusing.

As can be apparent from the foregoing description, due to the technical solution in which the first line-of-sight focus is corrected based upon the first correction data, the corrected second line-of-sight focus can be closer to the section indeed desirable for focusing by the user, thereby further achieving the technical effect of accurate focusing.

Of course, in a practical application, those skilled in the art may apply the solutions introduced above in combination under a practical condition to thereby accommodate a need in the practical condition, so a repeated description thereof will be omitted here for conciseness of the description.

Based upon the same inventive idea, an embodiment of the invention further provides an electronic device, and in a practical application, the electronic device may be a digital camera or may be a smart phone or may alternatively be another device of the same type without any limitation thereto.

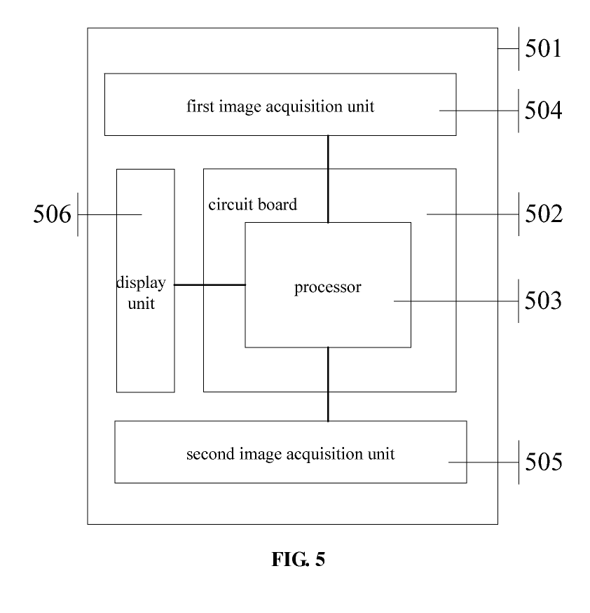

Referring to FIG. 5 illustrating a functional module diagram of an electronic device according to an embodiment of the invention, the electronic device includes: a housing 501; a circuit board 502 arranged inside the housing 501; a processor 503 arranged on the circuit board 502; a first image acquisition unit 504 arranged on the housing 501 and connected with the processor 503 to acquire an image of a first acquisition region; a second image acquisition unit 505 arranged on the housing 501 and connected with the processor 503 to obtain a line-of-sight focus of a first user; and a display unit 506 arranged on the housing 501 and connected with the processor 503, where when the image of the first acquisition region is acquired by the first image acquisition unit 504, the processor 503 is further configured to obtain by the second image acquisition unit a first line-of-sight focus of the first user viewing a preview image displayed on the display unit 506, to determine a first photographing focus of the first image acquisition unit 504 based upon the first line-of-sight focus, and to acquire by the first image acquisition unit 504 a first image of the first acquisition region based upon the first photographing focus, where a first section image in the first image has a higher definition than that of another section image in the first image than the first section, and the first section image is an image corresponding to the first photographing focus.

In a particular implementation, the electronic device further includes an obliquity detection unit, and the processor 503 is further configured to obtain by the obliquity detection unit an obliquity of the electronic device and to determine the first photographing focus based upon the first line-of-sight focus and the obliquity.

In a particular implementation, the processor 503 is further configured to determine a first position of the line-of-sight focus on the display unit 506, to determine the first position to correspond to a first sub-region of the first acquisition region and to determine the first sub-region as the first photographing focus.

In a particular implementation, the processor 503 is further configured to judge whether the line-of-sight focus stays at the first position for a period of time above a preset length of value, and to determine the line-of-sight focus to be at the first position in the case where it stays for the period of time above the preset length of time.

In a particular implementation, the processor 503 is further configured to obtain first correction data and to correct the first line-of-sight focus to second line-of-sight focus, where the first line-of-sight focus is different from the second line-of-sight focus.

The electronic device in this embodiment and the method for controlling an electronic device in the previous embodiment are two aspects under the same inventive idea, and with the detailed description above of the implementation of the method, those skilled in the art can appreciate clearly from the foregoing description the structure and implementation of the electronic device in this embodiment, so a repeated description thereof will be omitted here for conciseness of the description.

The technical solutions in the embodiments according to the embodiments of the invention have at least the following technical effects or advantages.

1. Due to the use of the technical solution in which the first line-of-sight focus of the first user is obtained, the first photographing focus of the first image acquisition unit is determined based upon the first line-of-sight focus, and the first image of the first acquisition region is acquired by the first image acquisition unit based upon the first photographing focus, the electronic device does not need to respond to any operation by the user to manually adjust the electronic device for focusing but instead determines the photographing focus of the image acquisition unit based upon the line-of-sight focus of the user to thereby achieve a technical effect of the scheme of focusing being more efficient than manual focusing.

2. Due to determination of the photographing focus of the electronic device based upon the line-of-sight focus of the user, the determined photographing focus is a photographing focus selected by the user himself or herself so that there is a technical effect of the scheme of focusing being more accurate than automatic focusing.

3. Due to the technical solution in which the obliquity of the electronic device is obtained by the obliquity detection unit, the first photographing focus is determined based upon the obliquity and the first line-of-sight focus, and the image is acquired based upon the first photographing focus, the determined photographing focus is a section indeed desirable for focusing by the user, thereby determining the photographing focus of the electronic device more accurately and thus further achieving the technical effect of accurate focusing.

4. Due to the technical solution in which the first line-of-sight focus is corrected based upon the first correction data, the corrected second line-of-sight focus can be closer to the section indeed desirable for focusing by the user, thereby further achieving the technical effect of accurate focusing.

Those skilled in the art shall appreciate that the embodiments of the invention may be embodied as a method, a system or a computer program product. Therefore the invention may be embodied in the form of an all-hardware embodiment, an all-software embodiment or an embodiment of software and hardware in combination. Furthermore the invention may be embodied in the form of a computer program product embodied in one or more computer useable storage mediums (including but not limited to a disk memory, a CD-ROM, an optical memory, etc.) in which computer useable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram may be embodied in computer program instructions. These computer program instructions may be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions may also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions may also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. A method for controlling an electronic device, applied to an electronic device comprising a display unit, a first image acquisition unit and a second image acquisition unit, wherein the first image acquisition unit is configured to determine a different acquisition region based upon a different focusing parameter, and the method comprises:
obtaining, by the second image acquisition unit, a first line-of-sight focus of a first user viewing a preview image displayed on the display unit in the case where an image of a first acquisition region is acquired by the first image acquisition unit;
determining a first photographing focus of the first image acquisition unit based upon the first line-of-sight focus; and
acquiring, by the first image acquisition unit, a first image of the first acquisition region based upon the first photographing focus, wherein a first section image in the first image has a higher definition than that of another section image in the first image than the first section, and the first section image is an image corresponding to the first photographing focus.

2. The method according to claim 1, wherein the electronic device further comprises an obliquity detection unit, and after the first line-of-sight focus of the first user operating the electronic device is obtained by the second image acquisition unit, and before the first photographing focus of the first image acquisition unit is determined, the method further comprises: obtaining, by the obliquity detection unit, an obliquity of the electronic device;
wherein the determining a first photographing focus of the first image acquisition unit based upon the first line-of-sight focus comprises: determining the first photographing focus of the first image acquisition unit based upon the first line-of-sight focus and the obliquity.

3. The method according to claim 1, wherein the determining a first photographing focus of the first image acquisition unit based upon the first line-of-sight focus comprises:
determining a first position of the first photographing focus on the display unit;
determining the first position to correspond to a first sub-region of the first acquisition region; and
determining the first sub-region as the first photographing focus.

4. The method according to claim 3, wherein the determining a first position of the first photographing focus on the display unit comprises:
judging whether the line-of-sight focus stays at the first position for a period of time above a preset length of time; and
determining the line-of-sight focus to be at the first position in the case where the line-of-sight focus stays for the period of time above the preset length of time.

5. The method according to claim 1, wherein after the first line-of-sight focus of the first user operating the electronic device is obtained by the second image acquisition unit, and before the first photographing focus of the first image acquisition unit is determined, the method further comprises:
obtaining first correction data; and
correcting the first line-of-sight focus to a second line-of-sight focus based upon the first correction data, wherein the first line-of-sight focus is different from the second line-of-sight focus.

6. An electronic device, comprising:
a housing;
a circuit board arranged inside the housing;
a processor arranged on the circuit board;
a first image acquisition unit arranged on the housing and connected with the processor to acquire an image of a first acquisition region;
a second image acquisition unit arranged on the housing and connected with the processor to obtain a line-of-sight focus of a first user; and
a display unit arranged on the housing and connected with the processor,
wherein in the case where the image of the first acquisition region is acquired by the first image acquisition unit, the processor is configured to obtain by the second image acquisition unit a first line-of-sight focus of the first user viewing a preview image displayed on the display unit, to determine a first photographing focus of the first image acquisition unit based upon the first line-of-sight focus, and to acquire by the first image acquisition unit a first image of the first acquisition region based upon the first photographing focus, wherein a first section image in the first image has a higher definition than that of another section image in the first image than the first section, and the first section image is an image corresponding to the first photographing focus.

7. The electronic device according to claim 6, wherein the electronic device further comprises an obliquity detection unit, and the processor is further configured to obtain an obliquity of the electronic device by the obliquity detection unit and to determine the first photographing focus based upon the first line-of-sight focus and the obliquity.

8. The electronic device according to claim 6, wherein the processor is further configured to determine a first position of the line-of-sight focus on the display unit, to determine the first position to correspond to a first sub-region of the first acquisition region and to determine the first sub-region as the first photographing focus.

9. The electronic device according to claim 8, wherein the processor is further configured to judge whether the line-of-sight focus stays at the first position for a period of time above a preset length of value, and to determine the line-of-sight focus to be at the first position in the case where the line-of-sight focus stays for the period of time above the preset length of time.

10. The electronic device according to claim 6, wherein the processor is further configured to obtain first correction data and to correct the first line-of-sight focus to second line-of-sight focus, wherein the first line-of-sight focus is different from the second line-of-sight focus.
